(19) United States
(12) Patent Application Publication
(10) Pub. No.: US 2023/0288131 A1
(43) Pub. Date: Sep. 14, 2023

(54) REFRIGERATOR AND METHOD FOR MANUFACTURING THE SAME

(71) Applicant: LG Electronics Inc., Seoul (KR)

(72) Inventor: Donghun LEE, Seoul (KR)

(21) Appl. No.: 18/019,138

(22) PCT Filed: Jul. 28, 2021
(86) PCT No.: PCT/KR2021/009763

§ 371 Date: Feb. 1, 2023

(30) Foreign Application Priority Data
Sep. 25, 2020 (KR) 10-2020-0124818

(51) Int. Cl. F25D 23/06; F25D 23/00

(52) U.S. Cl. CPC F25D 23/062; F25D 23/006

(57) ABSTRACT

A refrigerator includes a cabinet configured to define a storage space and a machine room which is separated from the storage space in the cabinet. A compressor, a condenser, and a cooling fan are configured to cool the storage space and disposed in the machine room. The compressor includes a shell configured to define an outer appearance of the compressor, a sealing pipe connected to the shell to inject a refrigerant into the shell, and a connection pipe connected to the sealing pipe. The connection pipe includes a body portion connected to the sealing pipe and a connection member passing through the body portion and welded to an end of the sealing pipe in a state of being in contact with the end of the sealing pipe when the body portion is inserted into the sealing pipe.

### TECHNICAL FIELD

The present disclosure relates to a refrigerator and a method for manufacturing the same.

### BACKGROUND ART

In general, refrigerators refer to home appliances in which food may be stored in an internal storage space, which is shielded by a door, at a low temperature. For this, the refrigerator is configured to accommodate the stored food in an optimum state by cooling the internal storage space using cold air generated through heat exchange with a refrigerant circulating in a refrigeration cycle.

In the structure of the general refrigerator, a machine room in which components such as a compressor and a condenser for driving a refrigeration cycle are disposed may be provided separately from the storage space. That is, as the machine room increases in volume, the storage space in the refrigerator may decrease in volume to relatively minimize a space of the machine room.

Therefore, it is difficult to work due to an insufficient space for connecting or assembling various devices performing heat exchange in the limited space of the machine room.

Korean Patent Publication No. 10-201.0-0063879 discloses a method for installing and assembling heat exchange devices provided in a machine room.

However, in the related art, a worker directly connects pipes connecting the heat exchange devices to each other through welding in a state in which the compressor and the condenser are seated on the bottom of the machine room. That is, there is a limitation in that the worker has to perform the welding using a welding rod so as to directly connect the pipes such as the compressor, thereby increasing in number of work to increase in loss of time and cost.

In addition, when the worker directly performs the pipe welding operation inside the machine room with the relatively narrow space, there is a limitation in that the operation is difficult, or an incorrect assembly occurs due to an incorrect selection of a work location.

### DISCLOSURE

### Technical Problem

Embodiments provide a refrigerator, in which high-frequency automatic welding is applied when a pipe such as a compressor is connected to the number of work, and a method for manufacturing the same.

Embodiments also provide a refrigerator, in which a welding ring is disposed at a fixed position without moving to enable automatic high-frequency welding, and a method for manufacturing the same.

Embodiments also provide a refrigerator, in which a corepressor is easily installed and connected.

### Technical Solution

In one embodiment, a refrigerator includes a connection pipe, to which a connection member serving as a welding rod is previously connected, to enable automatic high-frequency welding.

In another embodiment, a refrigerator includes: a cabinet configured to define a storage space; and a machine room which is separated from the storage space in the cabinet, wherein a compressor, condenser, and a cooling fan, which are configured to cool the storage space, are disposed in the machine room, wherein the compressor includes: a shell configured to define an outer appearance of the compressor; a sealing pipe connected to the shell to inject a refrigerant into the shell; and a connection pipe connected to the sealing pipe, wherein the connection pipe includes: a body portion connected to the sealing pipe; and a connection member passing through the body portion and welded to an end of the sealing pipe in a state of being in contact with the end of the sealing pipe when the body portion is inserted into the sealing pipe.

The body portion may include: an insertion portion inserted into the sealing pipe; and a coupling portion connected to the insertion portion and provided with the connection member.

The connection member may be spaced a set length from one end of the body portion.

The connection pipe may be inserted into the sealing pipe by a length of about 10 mm to about 20 mm.

The connection member may have an outer diameter that is equal to or greater than that of the sealing pipe.

The connection member may be provided in a coil shape that surrounds an outer circumferential surface of the body portion.

The connection member may be provided by stacking a plurality of rings, each of which has an opened center.

The connection member may include copper (Cu) as a main component.

The connection member may be welded with high frequency to fuse the sealing pipe and the connection pipe.

The compressor may include a suction pipe configured to suction the refrigerant into the compressor, the suction pipe may be connected to a suction connection pipe, and the suction connection pipe may include: a body portion inserted into the suction pipe; and a suction connection member provided along a circumference of an outer circumferential surface of the body portion, the suction connection member being configured to connect the suction pipe to the connection pipe through high-frequency welding.

The connection pipe may be inserted into the sealing pipe in a state in which the connection member is previously coupled to the connection pipe.

In further another embodiment, a method for manufacturing a refrigerator, which includes a cabinet configured to define a storage space; a machine room which is separated from the storage space in the cabinet, wherein a compressor, condenser, and a cooling fan, which are configured to cool the storage space, are disposed in the machine room, wherein the compressor includes: a shell configured to define an outer appearance of the compressor; a sealing pipe connected to the shell to inject a refrigerant into the shell; and a connection pipe connected to the sealing pipe, wherein the connection pipe includes: a body portion connected to the sealing pipe; and a connection member passing through the body portion, the connection pipe is coupled by allowing the connection member to pass through the body portion, the connection pipe to which the connection member is coupled is inserted into the sealing pipe, and high-frequency welding is performed in a state, in which an end of the sealing pipe is in contact with the connection member, to connect the sealing pipe to the connection pipe.

The body portion may include: an insertion portion inserted into the sealing pipe; and a coupling portion connected to the insertion portion, the coupling protrusion being provided with the connection member, wherein the insertion portion of the connection pipe may be inserted into the sealing pipe, and high-frequency welding may be applied to the connection member to connect the sealing pipe to the connection pipe.

The connection member may have an outer diameter that is equal to or greater than that of the sealing pipe.

The connection member may be provided in a coil shape that surrounds an outer circumferential surface of the body portion.

The compressor may include a suction pipe configured to suction the refrigerant into the compressor, in the suction pipe, a suction connection member may be coupled along a circumference of an outer circumferential surface of the body portion connected to the suction pipe, and in a state in which the suction connection pipe is inserted into the suction pipe; the suction pipe and the suction connection pipe may be connected to each other through high-frequency welding.

### Advantageous Effects

The refrigerator according to the embodiment may expect the following effects.

In the embodiment, the automatic high-frequency welding may be applied to the sealing pipe of the compressor by using the connection pipe to which the connection member serving as the welding rod is previously coupled. Therefore, the sealing pipe and the connection pipe may be connected to each other without performing the direct welding operation by the worker to reduce the number of work.

Also, the outer diameter of the connection member coupled to the connection pipe may be provided to be greater than the outer diameter of the sealing pipe so that when the worker inserts the connection pipe into the sealing pipe, the connection pipe may not be inserted beyond the connection member. That is, the connection pipe may be inserted into the sealing pipe by only the set length. Therefore, the limitation, in which the connection pipe is excessively inserted into the sealing pipe to affect the compressor shell, or the welding defects occurs, may be prevented.

In addition, the connection member may be provided in the coil shape surrounding the outer circumferential surface of the connection pipe body portion. Therefore, when the connection member is coupled once to the connection pipe, the connection member may not move so that the connection member is always disposed at the fixed position of the connection pipe.

### DESCRIPTION OF DRAWINGS

FIG. 1 is a view illustrating a state in which a machine room cover of a refrigerator and a configuration inside a machine room are separated from each other according to an embodiment.

FIG. 2 is a perspective view illustrating an internal structure of the machine room.

FIG. 3 is a perspective view of a compressor according to an embodiment.

FIG. 4 is a perspective view illustrating a state in which a connection pipe is coupled to the compressor.

FIG. 5 is an enlarged view of a portion A of FIG. 4.

FIG. 6 is an exploded view illustrating a state in which the connection pipe is separated according to an embodiment,

FIG. 7 is a perspective view of the connection pipe.

FIG. 8 is a cross-sectional view of a connection pipe manufacturing device according to an embodiment.

### MODE FOR INVENTION

Hereinafter, detailed embodiments will be described in detail with reference to the accompanying drawings. However, the scope of the present disclosure is not limited to proposed embodiments of the present invention, and other regressive inventions or other embodiments included in the scope of the spirits of the present disclosure may be easily proposed through addition, change, deletion, and the like of other elements.

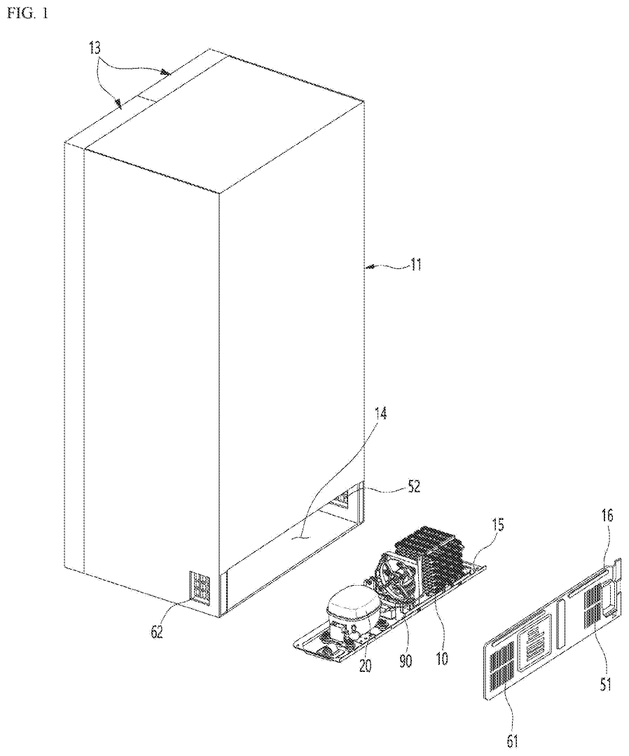

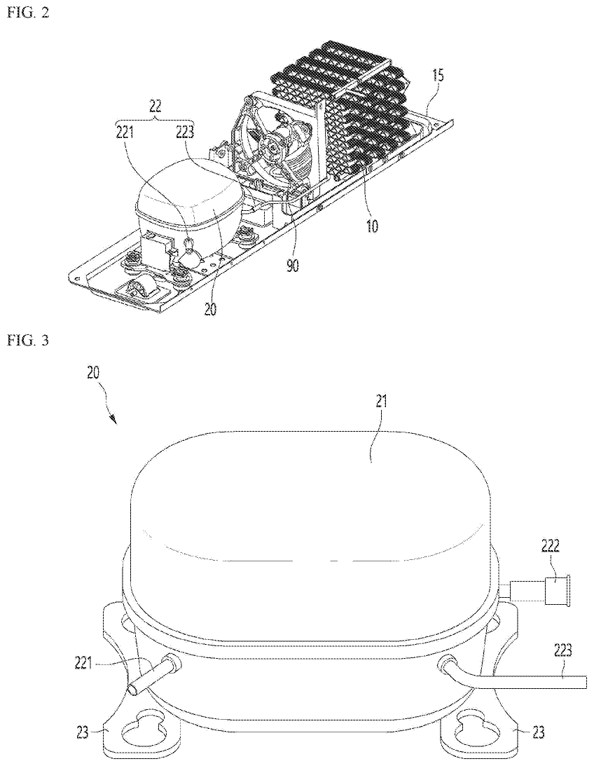

FIG. 1 is a view illustrating a state in which a machine room cover of a refrigerator and a configuration inside a machine room are separated from each other according to an embodiment. Also, FIG. 2 is a perspective view illustrating an internal structure of the machine room.

A refrigerator 1 according to an embodiment may have an outer appearance defined by a cabinet 11 defining a storage space and a door 13 that opens and closes the storage space.

Food may be stored in the storage space in a refrigerated or frozen state. The storage space may be provided by being divided into a plurality of storage compartments, and the plurality of storage compartments may be divided into a freezing compartment and a refrigerating compartment according to temperatures at which the food is stored.

The refrigerator 1 may include a refrigeration cycle device that generates cold air for cooling the storage space.

A machine room 14 in which the compressor 20 and a condenser 10 are provided may be defined in the refrigerator 1.

The refrigerator 1 may include a cooling fan 90 forcing a flow of air to cool the inside of the machine room 14.

The cooling fan 90 may force external air to be suctioned into the machine room 14 and then force the air to be discharged to the outside of the machine room 14 after passing through the condenser 10 and the compressor 20.

The machine room 14 may be defined at a lower portion of the refrigerator 1 and may be defined at a rear side of the lower portion of the refrigerator.

The machine room 14 may be partitioned from the storage space by a partition wall to provide an insulated space that is separated from the storage space. The partition wall that partitions the machine room 14 and the storage space from each other is provided with an insulating material so that a high temperature of the machine room 14 caused by an operation of the compressor 20 does not affect the storage space.

The machine room 14 may be opened to a rear side of the cabinet 11.

The refrigerator 1 may include a cover 16 that shields the rear opening of the machine room 14. The cover 16 may be detachably provided to the cabinet 11. Thus, it is possible to access the inside of the machine room 14 by opening the cover 16, and an installation work or maintenance work of components provided in the machine room 14 may be possible.

The refrigerator 1 may be provided with suction holes 51 and 52 through which external air is suctioned into the machine room 14 and discharge holes 61 and 62 through which air passing through the machine room 14 is discharged.

The suction holes 51 and 52 and the discharge holes 61 and 62 may be defined at left and right side in the machine room 14 so as to be spaced apart from each other. Also, the compressor 20 and the condenser 10 may be disposed in a region between the suction holes 51 and 52 and the discharge holes 61 and 62.

Thus, the air suctioned into the machine room 14 through the suction holes 51 and 52 may pass through the condenser 10 and the compressor 20 to cool the condenser 10 and the compressor 20. In addition, the air is heat-exchanged with the condenser 10 and the compressor 20 to become high-temperature air and then be discharged to the outside through the discharge holes 61 and 62.

The suction holes 51 and 52 may include a first suction hole 51 defined in the cover 16 and a second suction hole 52 defined in one side of the left and right sides of the machine room 14.

The discharge holes 61 and 62 may include a first discharge hole 61 defined in the cover 16 and a second discharge holes 62 defined in one of the left and right sides of the machine room 14.

For example, when the machine room 14 is viewed from the rear, the compressor 20 may be disposed at the left side of the machine room 14. Also, the condenser 10 may be disposed at the right side of the machine room 14. Also, the cooling fan 90 may be disposed between the compressor 20 and the condenser 10.

Here, the cooling fan 90 may be provided to force a flow of air from the condenser 10 to the compressor 20. Thus, the air suctioned into the machine room 14 through the suction holes 51 and 52 may cool the condenser 10 first and cool the compressor 20 and then be discharged through the discharge holes 61 and 62.

Of course, an arrangement position of the cooling fan 90 is not limited to this embodiment, i.e., may be disposed at various positions at which the air suctioned into the machine room 14 through the suction holes 51 and 52 is forced to sequentially pass through the condenser 10 and the compressor 20.

A bottom surface of the machine room 14 may be defined by a base 15. The base 15 may be provided in a plate shape corresponding to the bottom surface of the machine room 14. Also, the base 11 may be mounted on a lower end of the cabinet 11 to define the bottom surface of the machine room 14.

The compressor 20, the condenser 10, and the cooling fan 90 may be mounted on the base 15. Thus, after the compressor 20, the condenser 10, and the cooling fan 90 are mounted on the base 15, when the base 15 and the cabinet 11 are coupled to each other, the base 15 may be disposed inside the machine room 14.

FIG. 3 is a perspective view of the compressor according to an embodiment.

The compressor 20 according to an embodiment includes a shell 21 including a cylinder, a piston, a valve, and the like, and a plurality of pipes 22 capable of suctioning, discharging or injecting a refrigerant.

Also, a fixing plate 23 for facilitating the installation with the base 15 is provided at a lower end of the compressor 20. The fixing plate 23 may be fixed to an upper end of a stand protruding upward from the base 15 on which the compressor 20 is installed.

The plurality of pipes 22 include a suction pipe 222 allowing the refrigerant to be suctioned into the compressor 20, a discharge pipe 223 discharging the compressed refrigerant from the compressor 10, and a sealing pipe 221 charging the refrigerant into the compressor 10.

The refrigerant may be suctioned into the compressor 20 through the suction pipe 222. Also, the refrigerant suctioned through the suction pipe 222 may be compressed while flowing. Also, the compressed refrigerant may be discharged through the discharge pipe 223.

In detail, an outlet-side pipe of an evaporator constituting the refrigerating cycle is connected to the suction pipe 222, and an inlet-side pipe of the condenser is connected to the discharge pipe 223. Thus, a low-temperature and low-pressure gaseous refrigerant introduced from the evaporator is compressed into a high-temperature and high-pressure gaseous refrigerant in the compressor 20 and then is transferred to the condenser through the discharge pipe 223.

Also, the sealing pipe 221 may be coupled to one side of the compressor 20 to inject or supplement the refrigerant into the compressor 20.

The plurality of pipes 22 may be coupled to an outer circumferential surface of the compressor 20. Also, the plurality of pipes 22 may be coupled to be spaced a set interval from each other to avoid mutual interference therebetween, thereby improving work convenience.

The compressor 20 according to an embodiment includes a connection pipe 30 coupled to the sealing pipe 221 to guide a flow of the refrigerant. The connection pipe 30 may be coupled to the sealing pipe 221 through high-frequency welding while being inserted into the sealing pipe 221 by a set length.

Hereinafter, the connection pipe 30 according to an embodiment will be described in detail.

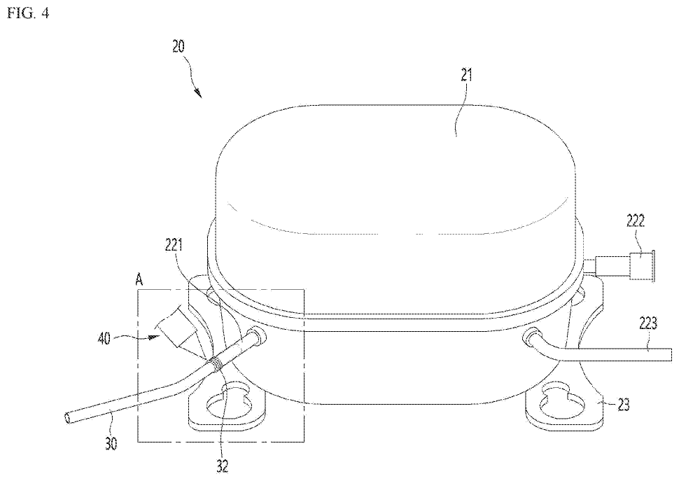

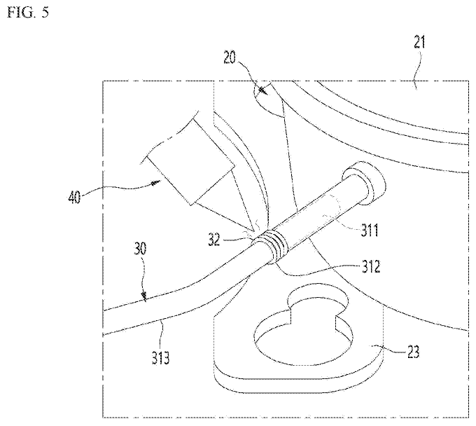

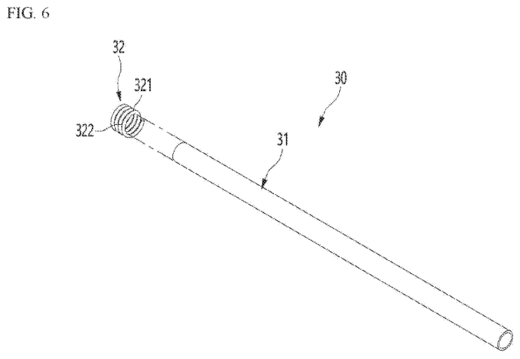

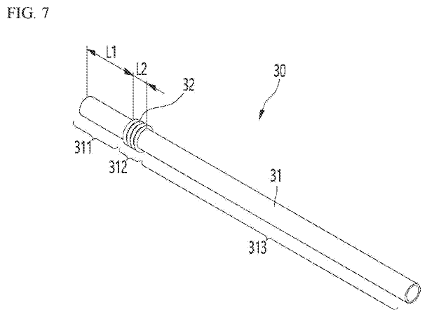

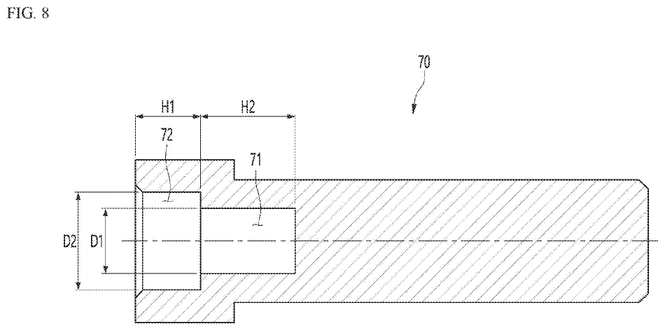

FIG. 4 is a perspective view illustrating a state in which the connection pipe is coupled to the compressor. Also, FIG. 5 is an enlarged view of a portion A of FIG. 4. Also, FIG. 6 is an exploded view illustrating a state in which the connection pipe is separated according to an embodiment. Also, FIG. 7 is a perspective view of the connection pipe.

The connection pipe 30 is partially inserted into the sealing pipe 221 and includes a body portion 31 connected to the sealing pipe 221 and a connection member 32 coupled to an outer circumferential surface of the body portion 31.

The body portion 31 includes an insertion portion 311 inserted into the sealing pipe 221, a coupling portion 312, which is connected to an end of the insertion portion 311 and to which the connection member 32 is coupled, and a connection portion 313 coupled to an end of the coupling portion 312 so as to be connected to an external pipe or tube. That is, one end of the body portion 31 may be defined as the insertion portion 311, and the other end of the body portion 31 may be defined as the connection portion 313, based on the coupling portion 312 to which the connection portion 313 is coupled.

The insertion portion 311 may be inserted into the sealing pipe 221 to a predetermined depth. That is, an outer diameter of the insertion portion 311 may be less than an inner diameter of the sealing pipe 221. Also, the connection member 32 may be coupled at intervals from one end of the body portion 31 by the set length so that the insertion portion 311 is always provided in the connection pipe 30 to a constant length.

For example, the connection member 32 may be coupled to be spaced apart from one end of the connection pipe 30 by a length of about 10 mm to about 20 mm, preferably about 13 mm to about 17 mm. In other words, a length L1 of the insertion portion 311 of the connection pipe 30 may be about 10 mm to about 20 mm, preferably about 13 mm to about 17 ram. Also, since the insertion portion 311 of the connection pipe 30 is inserted into the sealing pipe 221, a length to which the connection pipe 30 is inserted into the sealing pipe 221 may be about 10 mm to about 20 mm.

In detail, the connection member 32 is coupled to an outer circumferential surface of the connection pipe 30. Also, an outer diameter of the connection member 32 may be greater than an outer diameter of the sealing pipe 221. Thus, the worker inserts the connection pipe 30 into the sealing pipe 221 up to the end of the connection member 32 so that the connection pipe 30 is inserted into the sealing pipe 221 by the set length.

Thus, the worker may always insert the connection pipe 30 into the sealing pipe 221 by a certain length to improve the convenience of work and prevent welding defects due to mis-assembly, thereby improving welding quality.

The coupling portion 312 is a section, in which the connection member 32 is fitted, in the body portion 31, and the connection member 32 is provided on an outer circumferential surface of the coupling portion 312. Also, the coupling portion 312 may be a point at which the welding is performed by the connection member 32.

That is, in the state in which the body portion 31 is inserted into the sealing pipe 221, the connection member 32 and the end of the sealing pipe 221 are in contact with each other. That is, the connection pipe 30 may always be inserted into the sealing pipe 221 by the set length. Therefore, the connection member 32 may always be provided at the fixed position to prevent the welding defects due to the mis-assembly from occurring.

The connection pipe 30 is inserted into the sealing pipe 221 in a state in which the connection member 32 is previously coupled. Also, high-frequency welding may be performed on the connection member 32 to fix the connection pipe 30 to the sealing pipe 221.

Also, the connection portion 313 may be connected to the coupling portion 312 and then connected to a pipe into which the refrigerant is injected.

The connection member 32 according to an embodiment may be provided in a ring shape with an opened center so as to be fitted to the body portion 31. Also, the connection member 32 may be made of a metal material capable of high-frequency welding and may further include, for example, silver (Ag) or phosphorus (P) with copper (Cu) as a main component.

The connection member 32 may be provided in a coil shape surrounding the outer circumferential surface of the body portion 31. The connection member 32 may have a coil shape in which a wire having a circular cross-section is wound in a cylindrical shape. In other words, the connection member 32 may have a cylindrical shape surrounded by a coil around the coupling portion 312.

As another example, the connection member 32 may be provided by laminating a plurality of welding rings in the form of a ring having an opened center.

An outer surface of the connection member 32 may include a plurality of convex portions 321 and a valley 322 provided between the convex portions 321. Also, an inner surface of the connection member 32 may include a plurality of convex portions 321 and a valley 322 provided between the convex portions 321.

That is, in the state in which the connection member 32 is fitted to the connection pipe 30, the convex portions 321 press the outer surface of the connection pipe 30 to prevent the connection member 32 from moving at the fixed position of the connection pipe 30.

In this case, the connection member 32 may be more firmly fitted to the body portion 31, and the connection member 32 may be fixed without movement in the state of being coupled to the coupling portion 312.

A total length of the connection member 32 may be sufficient to allow welding between the connection pipe 30 and the sealing pipe 221 to be sufficiently performed, but is not limited thereto. As a specific example, the total length L2 of the connection member 32 may be provided to be about 1 mm to about 10 mm, preferably about 3 mm to about 7 mm. In other words, the length L2 of the coupling portion 312 to which the connection member 32 is coupled may, also be provided to be about 1 mm to about 10 mm, preferably about 3 mm to about 7 mm.

An inner diameter of the connection member 32 may be equal to or greater than an outer diameter of the connection pipe 30 so as to be fitted to the connection pipe 30. Also, an outer diameter of the connection member 32 may be greater than an outer diameter of the sealing pipe 221.

Due to this structure, the connection pipe 30 may be prevented from being inserted deeper into the sealing pipe 221 beyond the end of the connection member 32, and thus, the connection pipe 30 may be inserted into the sealing pipe 221 by the set length.

The connection member 32 may be previously coupled to the connection portion 312 of the connection pipe 30 before the connection pipe 30 is inserted into the sealing pipe 221. That is, the connection pipe 30 may be inserted and fixed inside the sealing pipe 221 in the state in which the connection member 32 is coupled. Also, the welding may be performed by applying high-frequency automatic welding machine 40 to the connection member 32. Thus, the connection member 32 may be fused to connect the connection pipe 30 to the sealing pipe 221.

According to an embodiment, to connect the sealing pipe 221 to the connection pipe 30 the worker may not directly perform the welding using a welding rod, but may perform the welding through the high-frequency automatic welding machine 40. Thus, there is an advantage in that convenience and productivity of the work are improved.

Also, according to an embodiment, although the method, in which the connection pipe 30 is inserted into the sealing pipe 221 of the compressor 20, and then the high-frequency welding is performed to couple the sealing pipe 221 to the connection pipe 30, the embodiment is not limited thereto.

For example, in addition to the sealing pipe 221 of the compressor 20, this method may also be applied to the suction pipe 222. The insertion portion 311 of the connection pipe 30 may be inserted into the suction pipe 222 to weld the connection member 32 provided on the coupling portion 312 by using a high-frequency welding device.

As another example, this method may also be applied to the discharge pipe 223 of the compressor 20. The discharge pipe and the connection pipe 30 may be connected to each other through the welding using the high-frequency welding device in the state in which the insertion portion 311 of the connection pipe 30 is inserted into the discharge pipe 223.

As another example, the connection pipe 30 according to an embodiment may be applied to a capillary tube that expands the refrigerant condensed in the condenser 10. In this case, sizes of the inner diameter and the outer diameter of the connection pipe 30 may be changed to a size that is capable of being inserted into the capillary tube. Also, the inner diameter and outer diameter of the connection member 32 may also be changed to a size that is not inserted into the capillary tube.

Hereinafter, a method for manufacturing the connection pipe 30 according to an embodiment will be described in detail.

FIG. 8 is a cross-sectional view of a connection pipe manufacturing device according to an embodiment.

In the connection pipe manufacturing device 70 according to an embodiment, in a state in which the connection member 32 is mounted on the connection pipe manufacturing device 70, the body portion 31 may be inserted into the connection pipe manufacturing device 70, and then, the connection member 32 may be separated in a state of being fixed to the outer circumferential surface of the body portion 31 to manufacture the connection pipe 30.

The connection pipe manufacturing device 70 may be provided in a circular or angular column shape and include a body insertion portion 71, in which the body portion 31 is inserted, and a mounting portion 72 on which the connection member 32 are mounted.

The body insertion portion 71 may be provided to have the same depth as a length of the insertion portion 311 of the connection member 32. That is, the body insertion portion 71 may be recessed from one end of the mounting portion 72 to be described later, and a recessed depth H2 may be the same as the length of the insertion portion 311 of the connection member 32.

Also, an inner diameter D1 of the body insertion portion 71 may correspond to an outer diameter of the body portion 31.

Also, the mounting portion 72 to which the connection member 32 is mounted may be disposed at one end of the body insertion portion 71. The mounting portion 72 may be recessed from one surface of the connection pipe manufacturing device 70 so that the connection member 32 is inserted into the connection pipe manufacturing device 70.

The mounting portion 72 may have a depth H1 that is recessed from one surface of the connection pipe manufacturing device 70 to correspond to the length of the connection member 32 or to be longer than that of the connection member 32.

An inner diameter D2 of the mounting portion 72 may correspond to an outer diameter of the connection member 32. In other words, the inner diameter of the mounting portion 72 may be greater than the inner diameter of the body insertion portion 71. That is, the body insertion portion 71 and the mounting portion 72 may have a height difference therebetween.

Due to this structure, in the state in which the connection member 32 is inserted into the mounting portion 72, the body portion 31 may be fitted into the body insertion portion 71 so that the connection member 32 is fixed to the body portion 31.

Also, when the body portion 31 is separated from the connection pipe manufacturing device 70 in the state in which the connection member 32 is fixed to the coupling portion 312, the connection pipe 30 on which the connection member 32 is mounted may be manufactured.

Here, milling processing may be performed on an outer circumferential surface of the connection pipe manufacturing device 70 so that the worker easily insert or separate the body portion 31.

As described above, the connection pipe 30 may be inserted into the sealing pipe 221 of the compressor 20 in the state in which the connection member 32 is previously coupled to the coupling portion 312. In this case, the connection pipe 30 may be inserted just before one end of the coupling portion 312 to which the connection member 32 is coupled. That is, in the connection pipe 30, only the insertion portion 311 may be inserted into the sealing pipe 221 and also always be inserted by the set length.

Also, in the state inserted into the sealing pipe 221 on the insertion portion 311 of the connection pipe 30, the high-frequency automatic welding machine 40 may perform the high-frequency welding on the connection member 32 so that the connection member 32 is fused to couple the sealing pipe 221 to the connection pipe 30.

Therefore, since the worker does not directly carry the welding rod for the welding, the number of work may be reduced to improve the productivity.

### INDUSTRIAL APPLICABILITY

In the embodiment, the automatic high-frequency welding may be applied to the sealing pipe of the compressor by using the connection pipe to which the connection member serving as the welding rod is previously coupled. The sealing pipe and the connection pipe may be connected to each other without performing the direct welding operation by the worker to reduce the number of work. Therefore, industrial applicability is significantly high.

1-16. (canceled)

17. A refrigerator comprising:
a cabinet that defines a storage space;
a machine room defined in the cabinet and separated from the storage space; and
a compressor, a condenser, and a cooling fan that are disposed in the machine room and configured to cool the storage space,
wherein the compressor comprises:
a shell that defines an outer appearance of the compressor,
a sealing pipe connected to the shell and configured to supply a refrigerant into the shell, and
a connection pipe connected to the sealing pipe, the connection pipe comprising:
a body portion inserted to the sealing pipe, and
a connection member penetrated by the body portion and welded to an end of the sealing pipe, the connection member being in contact with the end of the sealing pipe.

18. The refrigerator according to claim 17, wherein the body portion comprises:
an insertion portion inserted into the sealing pipe; and
a coupling portion connected to the insertion portion and in contact with the connection member.

19. The refrigerator according to claim 17, wherein the connection member is spaced apart from an end of the body portion.

20. The refrigerator according to claim 17, wherein the connection pipe is inserted into the sealing pipe by a length of 10 mm to 20 mm.

21. The refrigerator according to claim 17, wherein an outer diameter of the connection member is greater than or equal to an outer diameter of the sealing pipe.

22. The refrigerator according to claim 17, wherein the connection member has a coil shape that surrounds an outer circumferential surface of the body portion.

23. The refrigerator according to claim 17, wherein the connection member comprises a plurality of rings that are stacked, each of the plurality of rings defining a center opening.

24. The refrigerator according to claim 17, wherein the connection member comprises copper (Cu).

25. The refrigerator according to claim 17, wherein the connection member is welded by a high-frequency welding and connects the sealing pipe and the connection pipe to each other.

26. The refrigerator according to claim 17, wherein the compressor further comprises:
a suction pipe configured to supply the refrigerant into the compressor; and
a suction connection pipe connected to the suction pipe, and
wherein the suction connection pipe comprises:
a suction body portion inserted into the suction pipe, and
a suction connection member disposed along an outer circumferential surface of the suction body portion, the suction connection member being connected the suction pipe and the suction connection pipe by a high-frequency welding.

27. The refrigerator according to claim 17, wherein the connection pipe is inserted into the sealing pipe after the connection member has been coupled to the connection pipe.

28. A method for manufacturing a refrigerator, the refrigerator including a cabinet that defines a storage space, a machine room defined in the cabinet and separated from the storage space, and a compressor, a condenser, and a cooling fan that are disposed in the machine room and configured to cool the storage space, wherein the compressor includes a shell that defines an outer appearance of the compressor, a sealing pipe connected to the shell and configured to supply a refrigerant into the shell, and a connection pipe that is connected to the sealing pipe and includes a body portion connected to the sealing pipe and a connection member that receives the body portion, the method comprising:
coupling the connection member to the connection pipe, wherein coupling the connection member to the connection pipe comprises inserting the body portion into the connection member such that the body portion passes through the connection member;
based on coupling the connection member to the connection pipe, inserting the connection pipe into the sealing pipe; and
performing a high-frequency welding based on an end of the sealing pipe being in contact with the connection member to thereby connect the sealing pipe to the connection pipe.

29. The method according to claim 28, wherein inserting the body portion into the connection member comprises defining:
an insertion portion inserted into the sealing pipe; and
a coupling portion connected to the insertion portion and in contact with the connection member.

30. The method according to claim 28, wherein an outer diameter of the connection member is greater than or equal to an outer diameter of the sealing pipe.

31. The method according to claim 28, wherein the connection member has a coil shape that surrounds an outer circumferential surface of the body portion.

32. The method according to claim 28, wherein the compressor further comprises:
a suction pipe configured to supply the refrigerant into the compressor; and
a suction connection pipe connected to the suction pipe,
wherein the suction connection pipe comprises:
a suction body portion, and
a suction connection member disposed along an outer circumferential surface of the suction body portion, and
wherein the method further comprises:
inserting the suction connection pipe into the suction pipe, and
performing a high-frequency welding to connect the suction pipe and the suction connection pipe to each other.

33. The method according to claim 28, wherein the connection member is spaced apart from an end of the body portion.

34. The method according to claim 28, wherein the connection member comprises a plurality of rings that are stacked, each of the plurality of rings defining an opened center.

35. The method according to claim 28, wherein the connection member comprises copper (Cu).

36. The method according to claim 28, wherein the connection pipe is inserted into the sealing pipe by a length of 10 mm to 20 mm.
